(19) United States
(12) Patent Application Publication
(10) Pub. No.: US 2017/0154364 A1
(43) Pub. Date: Jun. 1, 2017

(54) METHOD AND SYSTEM FOR ECOMMERCE CUSTOMIZED PHOTO FULFILLMENT

(71) Applicant: Warren Struhl, Boca Raton, FL (US)

(72) Inventor: Warren Struhl, Boca Raton, FL (US)

(21) Appl. No.: 15/364,234

(22) Filed: Nov. 29, 2016

Related U.S. Application Data
(60) Provisional application No. 62/261,222, filed on Nov. 30, 2015.

(51) Int. Cl. G06Q 30/02; G06Q 30/06; H04L 12/58

(52) U.S. Cl. CPC G06Q 30/0271; H04L 51/10; G06Q 30/0277; G06Q 30/0621

(57) ABSTRACT

A method and system for fulfilling an ecommerce photograph or photograph product order includes receiving an email from a potential customer email address at order fulfillment system, confirming that the email includes a valid photograph attachment, and generating a product image with the valid photograph. The method or system can further include sending an offer email with an offer to the potential customer email address including the product image and a link to fulfill the offer for a product represented by the product image and sending and presenting a webpage in the form of an ordering page for the offer in response to actuating the link, where the ordering page includes fields for completing shipping, billing information, and quantity information.

### CROSS REFERENCE TO RELATED APPLICATIONS

### FIELD

The present disclosure generally relates to fulfillment of orders for merchandise and more particularly relates to a method and system for providing fulfillment of photo or customized photo arrangements.

### BACKGROUND

Conventionally creating a framed photograph can involve numerous steps including printing the photograph, sizing the photograph, purchasing a frame, optionally trimming the photograph, and inserting the photograph within the frame.

### BRIEF DESCRIPTION OF THE DRAWINGS

FIG. 1 is an illustration of a marketing promotion or advertisement on any number of electronic and non-electronic sources including, but not limited to television, Internet, radio, magazine, newspaper, or billboard promotions in accordance with embodiments of the present disclosure.

FIG. 2 is an illustration of an email sent to a potential customer as a result or in response to the potential customer sending an email with a valid photograph to a unique email address that initiates a process for ordering a customized framed photograph order including a link for the potential customer to order the customized framed photograph in accordance with an embodiment of the present disclosure.

FIG. 3 is an illustration of an electronic order form sent to the potential customer in response to the potential customer clicking a link such as a link labeled “Get It Now” in accordance with an embodiment of the present disclosure.

FIG. 4 is a flow chart illustrating a method in accordance with one of the embodiments of the present disclosure.

FIG. 5 is a block diagram of a system in accordance with one of the embodiments of the present disclosure.

### DETAILED DESCRIPTION

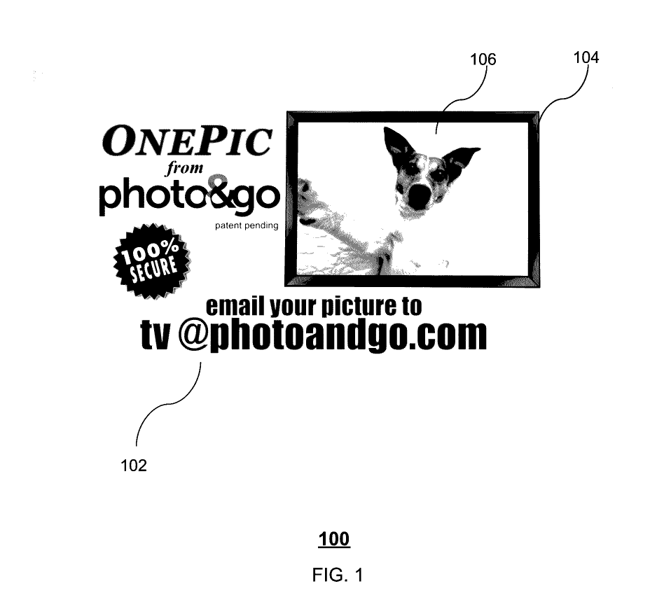

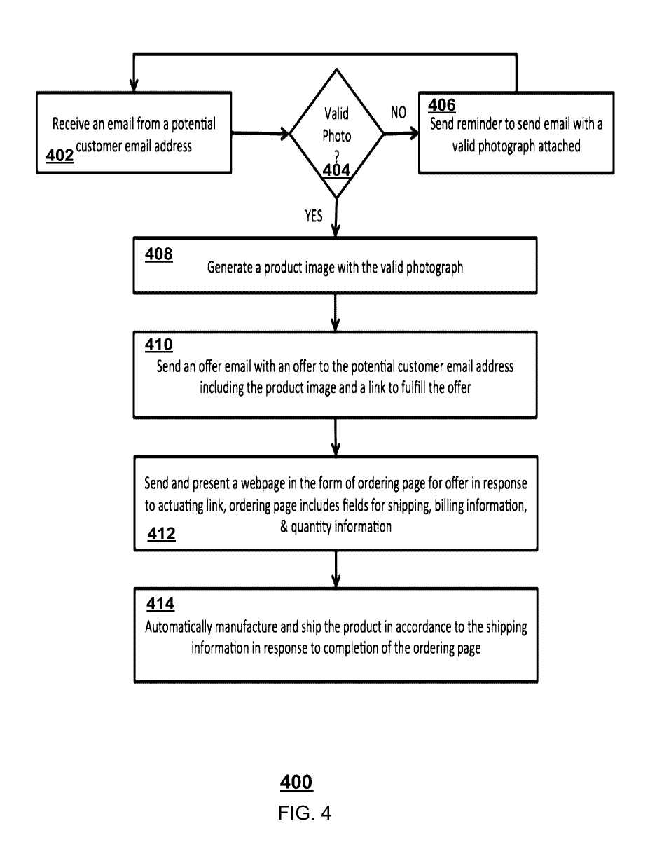

Referring to FIG. 1, as a first step, a potential customer views a marketing promotion 100 on TV, radio, web or a number of other vehicles as shown which instructs them to email their digital photo from any device (computer, smartphone, tablet, wi-fi enabled digital camera) to a unique email address (e.g. tv@photoandgo.com) 102 in order to purchase that photo on or with a custom photo product. A sample photo 106 and a sample custom photo product 104 are shown, but do not necessarily need to be part of the marketing promotion. For example, a radio marketing promotion would obvious not include such sample visual items. If the potential customer sends no picture or an invalid picture (e.g., a picture of an unsupported format) to the unique email address, an email can be sent to the customer email address reminding the customer of the issue (e.g., no picture sent or the picture was not of a valid format, see block 406 of FIG. 4). The supported photograph formats can be JPEG or PNG format or other formats if desired.

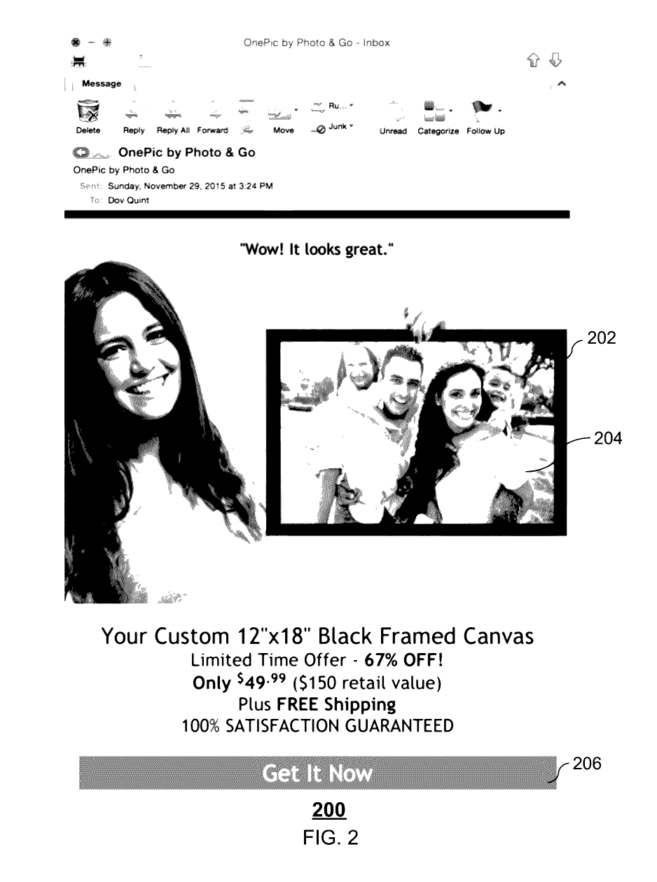

Referring to FIG. 2, as a subsequent step, the email from the customer to the unique email address initiates a process in which Photo & Go or other fulfillment center receives the inbound email from a POP email server. The system looks for a valid photo attachment in JPG or PNG format (or other designated formats), generates a product image (a “proof”) 202 with the attached photo 204, and within a short period of time (at most a few minutes) sends an email 200 back to the “from” address (assuming the email was from an address associated with Dov Quint, the email 200 would be sent back to the address associated with Dov Quint as shown in FIG. 2) of the inbound email offering the item (could be canvas, metal, wood, etc.) to the customer for purchase from the system website. If the customer chooses to take advantage of the offer, they simply click on the link 206 “GET IT NOW” to proceed with their purchase.

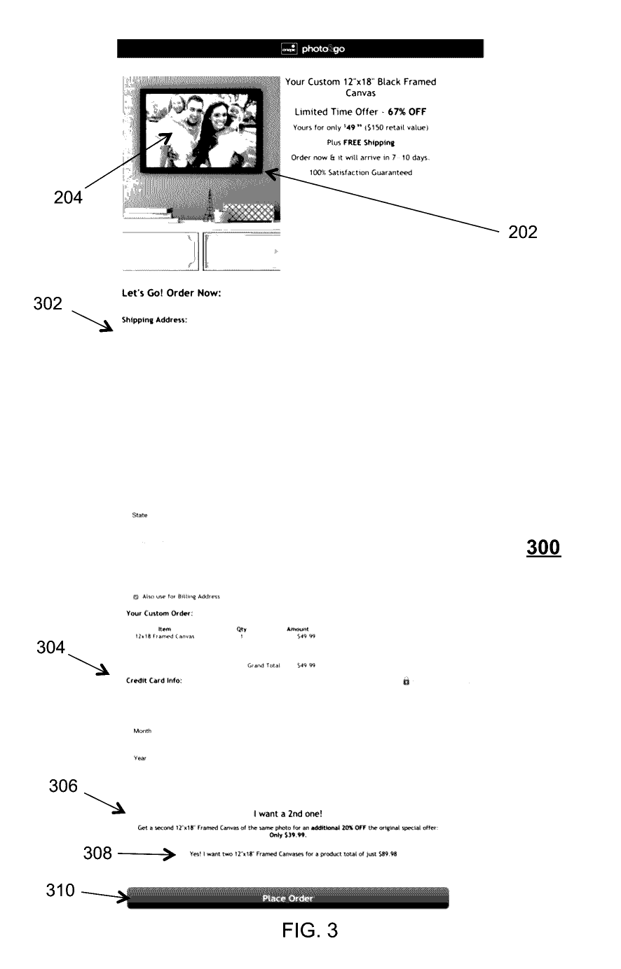

Referring to FIG. 3, once the potential customer clicks the “GET IT NOW” link 206 from FIG. 2, the potential customer is presented with the ordering page 300 where they are asked to complete their shipping information 302 and billing information 304. Optionally, the ordering page can show the product image 202 which could be a frame made of metal, wood, canvas, etc. that includes the photo 204. The ordering page 300 can further include other ordering options 306 such as an option 308 to confirm ordering a second item such as the a second picture and frame. The ordering page 300 can further include a link 310 to activate the placement of the order.

Referring to FIG. 4, a flow chart illustrating a method 400 in accordance with some of the embodiments of the present disclosure is shown. The method 400 begins with receiving at 402 an email from a potential customer email address at an order fulfillment system or server for managing and accomplishing some or all of the steps or functions disclosed herein. Note that although a particular embodiment is illustrated in FIG. 4, other embodiments are contemplated within the scope of the embodiments that only use some or some of the steps shown or where the steps are performed in a different order than those shown in FIG. 4. Next, the method 400 can confirm at 404 that the email includes a valid photograph attachment. If the no valid photograph is included in a received email from the potential customer email address, then at 406 a reminder is sent to the potential customer email address to send a valid photograph. If a valid photograph is received at 404, the method 400 can then generate at 408 a product image with the valid photograph and send an offer email at 410 with an offer to the potential customer email address including the product image and a link to fulfill the offer for a product represented by the product image. If the link is activated, the system can then responsively send and present a webpage at 412 in the form of an ordering page for the offer in response to actuating the link, wherein the ordering page includes fields for completing shipping, billing information, and quantity information. In some embodiments, the ordering page includes fields for customizing the order such as changing the size of the picture or frame or color of the frame, or the quantity of products ordered. The customizing options can be part of the ordering options 306 section previously shown with respect to FIG. 3. In some embodiments, the offer can include incentives or discounts for ordering more than a single product or other volume discount offers. In some embodiments, the offer can include additional offers or incentives for ordering other products that can include use of the submitted photo incorporated into products or just other products unrelated to the submitted photo. In a simple embodiment as disclosed, the offer can be for purchase of the valid photograph in a framed canvas such as a black framed canvas or an actual picture in a frame. In some embodiments, the potential customer email address corresponds to an email address of any one of a computer, smartphone, laptop, tablet, phablet, or wi-fi or other wireless enabled digital camera. In a last step, the method 400 can automatically manufacture and ship the product at step 414 in accordance to the shipping information in response to completion of the ordering page. In some embodiments, some of the steps can be done manually instead of automatically.

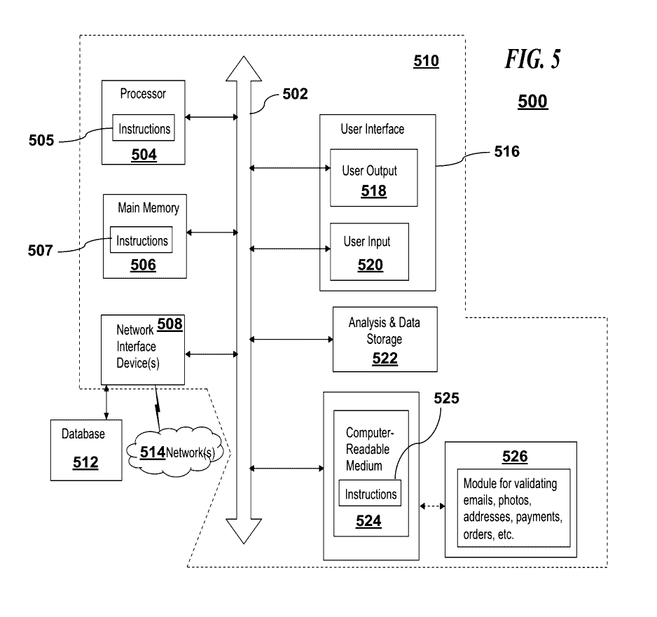

Referring to FIG.5, an information processing system or other system 500 can be communicatively coupled with a module 526 for validating emails, photographs, addresses, payments, orders or other items of information which can be integrated with the information processing system 500. According to this example, at least one processor 504, responsive to executing instructions 505, performs operations to communicate with the module 526 via a bus architecture, as shown using bus 502 for example. The at least one processor 504 is communicatively coupled with main memory 506 having instructions 507 or other memory, and a computer readable medium 524 which can contain instructions 525. The processor 504 is communicatively coupled with an Analysis & Data Storage 522 that, according to various implementations, can maintain stored information used by, for example, the module 526 and more generally used by the information processing system 500 or 510. Additionally, according to another example, an order history log of an order history of photo products can be maintained stored in the Analysis & Data Storage. The module 526, and the information processing system 500 or 510, can use the information from the order history log.

The information processing system 500 or 510 includes a user interface 516 that comprises a user output interface 518 and user input interface 520. Examples of elements of the user output interface 518 can include a display, a speaker, one or more indicator lights, one or more transducers that generate audible indicators, and a haptic signal generator. Examples of elements of the user input interface 520 can include a keyboard, a keypad, a mouse, a track pad, a touch pad, a microphone that receives audio signals. The received audio signals, for example, can be converted to electronic digital representation and stored in memory, and optionally can be used with voice recognition software executed by the processor 504 to receive user input data and commands.

A network interface device 508 is communicatively coupled with the processor 504 and provides a communication interface for the information processing system to communicate via one or more networks 514. The networks can include wired and wireless networks, and can be any of local area networks, wide area networks, or a combination of such networks. For example, wide area networks including the internet and the web can inter-communicate the information processing system with other one or more information processing systems that may be locally, or remotely, located relative to the information processing system. It should be noted that mobile communications devices, such as mobile phones, Smart phones, tablet computers, phablets, lap top computers, and the like, which are capable of at least one of wired and/or wireless communication, are also examples of information processing systems within the scope of the present disclosure. The network interface device 508 can provide a communication interface for the information processing system 510 to access the database 512 according to various embodiments of the disclosure.

The instructions, according to the present example, include instructions for performing the functions described with respect to the flow chart of FIG. 4. It should be noted that any portion of the instructions can be stored in a centralized information processing system or can be stored in a distributed information processing system, i.e., with portions of the system distributed and communicatively coupled together over one or more communication links or networks. Existing networks and email systems do not include means for validating emails, photos, addresses, payments, and orders as disclosed herein.

The present invention may be a system, a method, and/or a computer program product. The computer program product may include a computer readable storage medium (or media) having computer readable program instructions thereon for causing a processor to carry out aspects of the present invention.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer readable program instructions described herein can be downloaded to respective computing/processing devices from a computer readable storage medium or to an external computer or external storage device via a network or networks, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems), and computer program products according to embodiments of the invention. It will be understood that each block of the flowchart illustrations and/or block functional diagrams, and combinations of blocks in the flowchart illustrations and/or block functional diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or functional block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the computer readable storage medium is shown in an example embodiment to be a single medium, the term “computer readable storage medium” should be taken to include a single medium or multiple media (e.g., a centralized or distributed database, and/or associated caches and servers) that store the one or more sets of instructions. The term “computer-readable storage medium” shall also be taken to include any non-transitory medium that is capable of storing or encoding a set of instructions for execution by the machine and that cause the machine to perform any one or more of the methods of the subject disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a computer-readable storage medium, as listed herein and including art-recognized equivalents and successor media, in which the software implementations herein are stored.

Although the present specification may describe components and functions implemented in the embodiments with reference to particular standards and protocols, the disclosure is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor is illustrated for an information processing system, information processing systems with multiple CPUs or processors can be used equally effectively. Various embodiments of the present disclosure can further incorporate interfaces that each includes separate, fully programmed microprocessors that are used to off-load processing from the processor. An operating system (not shown) included in main memory for the information processing system may be a suitable multitasking and/or multiprocessing operating system, such as, but not limited to, any of the iOS, Linux, UNIX, Windows, and Windows Server based operating systems. Various embodiments of the present disclosure are able to use any other suitable operating system. Various embodiments of the present disclosure utilize architectures, such as an object oriented framework mechanism, that allows instructions of the components of operating system (not shown) to be executed on any processor located within the information processing system. Various embodiments of the present disclosure are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device, a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A method comprising:
receiving an email from a potential customer email address at an order fulfillment system;
confirming at the order fulfillment system that the email includes a valid photograph attachment;
generating a product image with the valid photograph; and
sending an offer email with an offer to the potential customer email address including the product image and a link to fulfill the offer for a product represented by the product image.

2. The method of claim 1, further comprising sending and presenting a webpage in the form of an ordering page for the offer in response to actuating the link, wherein the ordering page includes fields for completing shipping, billing information, and quantity information for an order of the product.

3. The method of claim 2, wherein the ordering page includes fields for customizing the order.

4. The method of claim 1, wherein the potential customer email address corresponds to an email address of any one of a computer, smartphone, laptop, tablet, phablet, or wi-fi enabled digital camera.

5. The method of claim 1, wherein the offer is for a purchase of the valid photograph on or in a custom photo product.

6. The method of claim 1, wherein the offer is for a purchase of the valid photograph in a framed canvas.

7. The method of claim 2, further comprising automatically manufacturing and shipping the product in accordance to the shipping information in response to completion of the ordering page.

8. The method of claim 1, further comprising sending a reminder email with a reminder message to the potential customer email address in response to receiving the email from the potential customer email address without a photograph or without a valid photograph.

9. A system comprising:
a memory having computer instructions;
one or more processors, when executing the computer instructions, causing the one or more processors to perform the operations of:
receiving an email from a potential customer email address at order fulfillment system or server;
confirming that the email includes a valid photograph attachment;
generating a product image with the valid photograph; and
sending an offer email with an offer to the potential customer email address including the product image and a link to fulfill the offer for a product represented by the product image.

10. The system of claim 9, further comprising computer instructions when executed by the one or more processors to cause the one or more processors to perform the operations of sending and presenting a webpage in the form of an ordering page for the offer in response to actuating the link, wherein the ordering page includes fields for completing shipping, billing information, and quantity information.

11. The system of claim 10, wherein the ordering page includes fields for customizing the order.

12. The system of claim 9, wherein the potential customer email address corresponds to an email address of any one of a computer, smartphone, laptop, tablet, phablet, or wi-fi enabled digital camera.

13. The system of claim 9, wherein the offer is for a purchase of the valid photograph on or in a custom photo product.

14. The system of claim 9, wherein the offer is for a purchase of the valid photograph in a framed canvas.

15. The system of claim 10, further comprising computer instructions when executed by the one or more processors to cause the one or more processors to perform the operations of automatically manufacturing and shipping the product in accordance to the shipping information in response to completion of the ordering page.

16. The system of claim 9, further comprising computer instructions when executed by the one or more processors to cause the one or more processors to perform the operation of sending a reminder email with a reminder message to the potential customer email address in response to receiving the email from the potential customer email address without a photograph or without a valid photograph.

17. A system comprising:
a memory having computer instructions;
one or more processors, when executing the computer instructions, causing the one or more processors to perform the operations of:
receiving an email from a potential customer email address at order fulfillment system or server;
validating the potential customer email address;
validating that the email includes a valid photograph as an attachment;
generating a product image with the valid photograph; and
sending an offer email with an offer to the potential customer email address including the product image and a link to fulfill the offer for a product represented by the product image.

18. The system of claim 17, further comprising computer instructions when executed by the one or more processors to cause the one or more processors to perform the operation of sending a reminder email with a reminder message to the potential customer email address in response to receiving the email from the potential customer email address without a photograph or without a valid photograph.

19. The system of claim 17, wherein the offer includes additional offers or incentives for ordering other products that includes use of the valid photograph.

20. The system of claim 17, wherein the one or more processors comprises a module for validating emails, photos, addresses, payments, and orders.
